(19) United States
(12) Patent Application Publication
(10) Pub. No.: US 2007/0198262 A1
(43) Pub. Date: Aug. 23, 2007

(54) Topological voiceprints for speaker identification

(76) Inventors: Bernardo Gabriel Mindlin, Buenos Aires (AR); Marcos Alberto Trevisan, Buenos Aires (AR); Manuel Camilo Eguia, Buenos Aires (AR)

Correspondence Address: FISH & RICHARDSON, PC, P.O. BOX 1022, MINNEAPOLIS, MN, 55440-1022, US

(21) Appl. No.: 10/568,564

(22) PCT Filed: Aug. 20, 2004
(86) PCT No.: PCT/US04/27193

§ 371 Date: Aug. 30, 2006

Related U.S. Application Data
(63) Continuation-in-part of application No. 60/497,007, filed on Aug. 20, 2003.

(51) Int. Cl. G10L 17/00

(52) U.S. Cl. 704/246

(57) ABSTRACT

The speaker recognition techniques of this application use a topological description of his/her voice spectral properties in order to use it as a biometric characterization for the speaker. Distinctly different from computing distances between spectral curves obtained from voices of different speakers in various spectral analysis methods, such topological features provide a one-to-one correspondence between a subject and a mold represented by a set of rational numbers.

This application claims the benefit of U.S. Provisional Patent Application No. 60/497,007 entitled “TOPOLOGICAL VOICEPRINTS FOR SPEAKER IDENTIFICATION” and filed Aug. 20, 2003, the entire disclosure of which is incorporated herein by reference as part of the specification of this application.

### BACKGROUND

This application relates to identification of speakers by voices.

Voices of different persons have different voice characteristics. The differences in voice characteristics of different persons can be extracted to construct unique identification tools to distinguish and identify speakers. To a certain extent, speaker recognition is a process of automatically recognizing who is speaking on the basis of individual information obtained from voices or speech signals. In various applications, speaker recognition may be divided into Speaker Identification and Speaker Verification. Speaker identification determines which registered speaker provides a given utterance amongst a set of known speakers. The given utterance is analyzed and compared to the voice information of the known speakers to determine whether there is a match. In speaker verification, an unknown speaker first claims an entity of a known speaker and an utterance from the unknown speaker is obtained and compared against voice information of the claimed known speaker to determine whether there is a match.

Speaker recognition technology has many applications. For example, a speaker's voice may be used to control access to restricted facilities, devices, computer systems, databases, and various services, such as telephonic access to banking, database services, shopping or voice mail, and access to secured equipment and computer systems. In both speaker identification and verification, users are required to “enroll” in the speaker recognition system by providing examples of their speech so that the system can characterize and analyze users' voice patterns.

In the field of speaker recognition, various speaker recognition methods have been developed to use distances between vectors of voice features, e.g., spectral parameters, to identify speakers. In such spectral analysis methods, the distances between extracted voice features and voice templates of known speakers are computed. Based on statistical or other suitable analysis, if the computed distances for received voices or utterances are within predetermined threshold values for a known speaker, then received voices or utterances are assigned to that known speaker.

### SUMMARY

The speaker recognition techniques described in this application were developed in part based on the recognition of various technical limitations in various spectral analysis methods based on computation of distances of spectral parameters. For example, such spectral analysis methods may not be sufficiently accurate at least because different utterances of the same speaker may have somewhat different spectra and the decision is essentially dependent on a voice spectral database that is used to fit the appropriate threshold.

The speaker recognition techniques of this application use topological features in voices that are computed from each individual speaker to construct a set of discrete rational numbers, such as integers, as a biometric characterization for each speaker and use such rational numbers to identify a speaker or a subject under examination. Distinctly different from computing distances between spectral curves obtained from voices of different speakers in various spectral analysis methods, such topological features provide a one-to-one correspondence between a subject and a mold or voiceprint represented by a set of rational numbers. Therefore, a database of such rational numbers for different known speakers may be formed for various applications, including speaker identification and verification. A database of such rational numbers is small relative to a conventional voice databank for a person used in various spectral analysis methods. Each voice print includes a set of topological parameters in form of discrete integers or rational numbers to distinguish a speaker from other speakers and is derived from an embedding of spectral functions of the speaker's voice.

In one implementation, a method for determining an identity of a speaker by voice is described. First, a set of topological indices are extracted from an embedding of spectral functions of a speaker's voice. Next, a selection of the topological indices is used as a biometric characterization of the speaker to identify and verify the speaker from other speakers.

In another implementation, the topological parameters are rational numbers such as integers obtained from the relative rotation rates (rrr). Each subject is assigned with a set of rational numbers that can be reconstructed from brief utterances. A subset of these numbers does not change from utterance to utterance of the same speaker, and are different from subject to subject. In this way, a standard way to describe the voice can be established, independently of the size of the features of the database. The set of rational numbers characterizing the voice is robust, and can be easily coded in various devices, such as magnetic or printed devices.

An exemplary method described in this application includes the following steps. A speech signal from a speaker is recorded and digitized. Linear prediction coefficients of the discrete signal are computed. The power spectrum is computed from the linear prediction coefficients. Next, a three-dimensional periodic orbit is constructed from the power spectrum and a second three-dimensional periodic orbit is also constructed from a power spectrum of a reference such as a natural reference signal. The topological information about the periodic orbits of the speech signal and the natural reference signal is then obtained. A selective set of topological indices is used to distinguish a speaker who produces the speech signal from other speakers who have different topological indices.

This application also describes speaker recognition systems. In one example, a speaker recognition system includes a microphone to receive a voice sample from a speaker, a reader head to read voice identification data of rational numbers that uniquely represent a voice of a known speaker from a portable storage device, and a processing unit. The processing unit is connected to the microphone and the reader head and is operable to extract topological information from the voice sample of the speaker to produce topological discrete numbers from the voice sample. The processing unit is also operable to compare the discrete numbers of the known speaker to the topological discrete numbers from the voice sample to determine whether the speaker is the known speaker. Because the file size for digital codes of the discrete rational numbers for speaker recognition is sufficiently small, one or more voiceprints for one or more speakers can be stored in the portable storage device that can be carried with a user.

These and other examples and implementations are described in greater detail in the attached drawing, the detailed description, and the claims.

### BRIEF DESCRIPTION OF THE DRAWING

FIG. 1 shows examples of periodic functions used for the embedding from a single speaker (solid lines) and a universal reference (dotted line). These functions are constructed from the original log |H(ƒ)|² using one half of the original period.

FIG. 2 shows three examples of log |H(ƒ)|² using the maximum entropy approximation for two different speakers over the complete period of the function. Beyond the second formant, the spectra naturally cluster in two different groups. The original sound segments correspond to the Spanish vowel [a] extracted from normal speech utterances.

FIG. 3 shows an example of a delay embedding (Δf=40 Hz) of the function F(f) computed from one voiced fragment (solid line).

FIG. 4 shows vowelprints for three male speakers of nearly the same age, constructed from short vowel segments (˜100 ms) of around 10 utterances taken in different enrollment sessions.

FIG. 5A shows an example of a voice sample as a function of time obtained from a speaker via a microphone.

FIG. 5B shows a power spectrum obtained from the voice sample in FIG. 5A.

FIG. 5C illustrates linking of two three-dimensional orbits 1 and 2 in the topological approach to extract rotation numbers from voice signals.

FIG. 5D shows relative rotation numbers from the relative topological relation between an orbit constructed from a voice sample and a reference orbit from a reference signal.

FIGS. 6A, 6B, and 6C illustrate an example of the process to select invariant rotation numbers from multiple rotation matrices for the same voiced sound of a speaker as the voiceprint for the speaker.

FIG. 7 shows an example of comparing voice of a unknown speaker to a voiceprint of a known speaker in a full match analysis.

FIG. 8 illustrates a procedure for verifying two candidates against three voiceprints of three known speakers.

FIG. 9 shows an example of a speaker recognition system.

FIG. 10 shows operation of the system in FIG. 9.

### DETAILED DESCRIPTION

The speaker recognition techniques described here may be implemented in various forms. In one implementation, for example, a set of discrete rational numbers (e.g., integers) is extracted from voice samples of a speaker. A subset of the extracted rational numbers are present in each utterance of the speaker and do not vary from utterance to utterance of the speaker under normal speech conditions, and low noise environment. This subset is called voiceprint, and it is used as a biometric characterization of the speaker to identify and verify the speaker from other speakers.

Hence, speaker verification may be achieved with this biometric characterization by the following steps. First, a voice sample from a second speaker is analyzed to extract a set of rational numbers for the second speaker. The set of discrete rational numbers for the second speaker is compared to the voiceprints for the speaker without using a threshold value in the comparison. The second speaker is then verified as the speaker when there is a perfect match between the set of rational numbers for the second speaker and the voiceprint for the speaker. If there is not a match, the second speaker is identified as a person different from the speaker.

In an implementation for speaker identification, voiceprints are extracted from voice samples of different known speakers. Next, a voice sample from a unknown speaker is analyzed to extract a set of rational numbers for the unknown speaker and the set of discrete rational numbers for the unknown speaker is compared to the voiceprints of the known speakers to determine whether there is a match in order to identify whether the unknown speaker is one of the known speakers.

Notably, in the above speaker verification and identification processes, a comparison between different sets of discrete rational numbers is made to determine a match. There is no need to determine whether a difference between two spectral features is within a selected threshold value. This and other features of the speaker recognition techniques described here are advantageous over various spectral analysis methods based on computation of distances of spectral parameters.

Voice recognition methods are noninvasive identification methods and thus, in this regard, are superior to other biometric identification procedures such as retina scanning methods. However, spectral analysis methods for speaker recognition are not as widely used as other biometric procedures including fingerprinting in part because of the difficulty of establishing how close is sufficiently close for a positive identification when comparing spectral features in different voices. The speaker recognition techniques described here avoid the uncertainties in using threshold values to compare spectral features and provide a novel approach to the extraction of biometric features from speech spectral information.

The spectral properties of voices of persons are known to carry unique traits of the speakers and thus can be used for speaker recognition. During the production of voiced sounds a spectrally rich sound signal produced by the modulation of the airflow by the vocal folds is filtered by the vocal tract of the speaker. The resonances of the vocal tract as a passive filter are determined by ergonomic features of the speaker, and therefore can be used to identify the speaker. The physics of human voice can be described in terms of the standard source-filter theory. During the production of voiced sounds like vowels, the airflow induces periodic oscillations in the vocal folds. These oscillations generate time varying pressure fluctuations at the input of a passive linear filter, the vocal tract. The separation between source and filter assumes that the feedback into fold oscillations is negligible, a hypothesis that has been extensively validated for normal speech regime by Laje et al. in Phys. Rev. E64, 05621 (2001). The spectrally rich input pressure presents harmonics of a fundamental frequency of about 100 Hz. The vocal tract selects some frequencies out of these harmonics. In this way, the spectrum of a voiced sound carries information about the vocal tract that is unique to each speaker and therefore can be used as a biometric characterization of the speaker.

A typical approach in the field of speaker recognition, such as various spectral analysis methods, is to use feature vectors with quantities that characterize different subjects, perform multidimensional clustering and separate the clusters associated with the different subjects by means of some metric on the feature vectors. In the framework of the spectral characterization of the voice, one way to perform an identity validation is to construct a distance between properties computed from utterances (distortion measures), such as the integral of the difference between the two spectra on a log magnitude. Another distortion measure is based upon the differences between the spectral slopes, e.g., the first order derivatives of the log power spectra pair with respect to frequency.

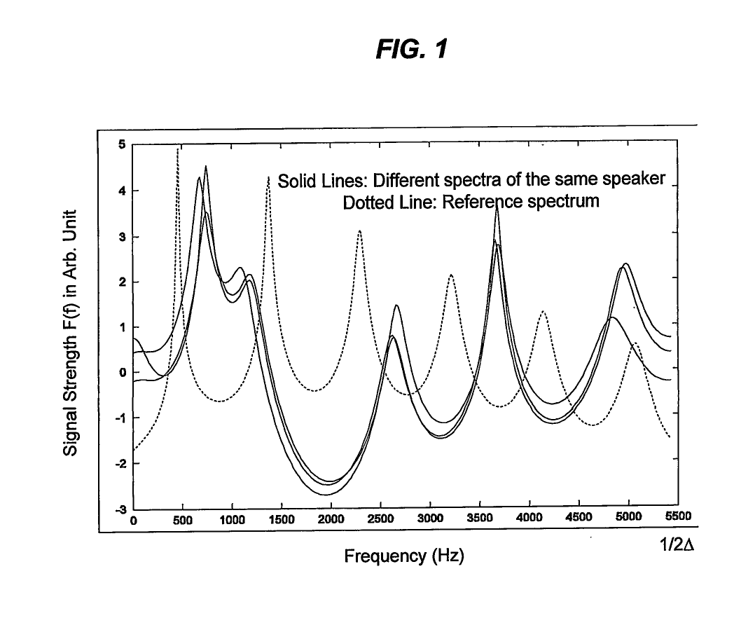

Such spectral analysis methods suffer a number of technical limitations. FIG. 1 shows examples of log power spectra of three different utterances by the same speaker. The spectra are somewhat different in the spectral peaks and shapes for different utterances from the same speaker. Hence, in computing differences between spectral features, it is inherently difficult and challenging to measure the distances between curves and decide how much deviation is acceptable for speaker recognition. For example, the computed results from such spectral analysis methods are generally scattered between ranges for different speakers. As such, uncertainties exist as to where to set the boundary between acceptable values between two speakers whose ranges are close.

The speaker recognition techniques described here use an entirely different approach to extraction unique biometric features from voices and utterances. The above spectral comparison may be alternatively implemented by means of another set of coefficients called cepstrum coefficients that are the Fourier amplitudes of the spectral function. To a degree, this implementation may be understood as that the voice spectrum is treated as a “time” series where the frequency, f, plays the role of time. Under this view, the present inventors discovered that the techniques used in the theory of dynamical systems in order to compare two periodic orbits can be used in the analysis of voiced sound spectra. This approach to voice information completely avoids the computation of differences of spectral features. In particular, the inventors explored the use of topological tools that are designed to capture the main morphological features of orbits regardless of slight deformations. Topological analysis of nonlinear dynamical systems is a well established technical field and the basic principles and analytical framework are described in detail by Robert Gilmore in “Topological analysis of chaotic dynamical systems” in Review of Modern Physics, Vol. 70, No. 4, pages 1455-1529 (October, 1998).

The following sections describe how to characterize spectra by means of sets of rational numbers by using topological tools developed in a different field for dynamical systems. Notably, within a relatively small bank of speakers, there are subsets of rational numbers that seem to strengthen the speakers' identity information. These results suggest new direction in the identification of subjects by voice: one in which arrangements of rational numbers define voiceprints that stand on their own, despite any acceptance/rejection thresholds.

In the analysis of three-dimensional dynamical systems, the periodic orbits are closed curves that can be characterized by the way in which they are knotted and linked to each other and to themselves. See, e.g., Solari and Gilmore in “Relative rotation rates for driven dynamical systems;” Physical Review A37, pages 3096-3109 (1998), Mindlin et al. in “Classification of strange attractors by rational numbers,” Physical Review Letters, Vol. 64, pages 2350-2353 (1990), and Mindlin and Gilmore in Physica D58, page 229 (1992). For the purpose of applying this analysis to the problem of speaker identification, the power spectrum of voiced sounds on a log scale is treated as a periodic string of data, using techniques commonly applied to the analysis of periodic “time” series. A three dimensional orbit can be constructed from this string of data using a delay embedding.

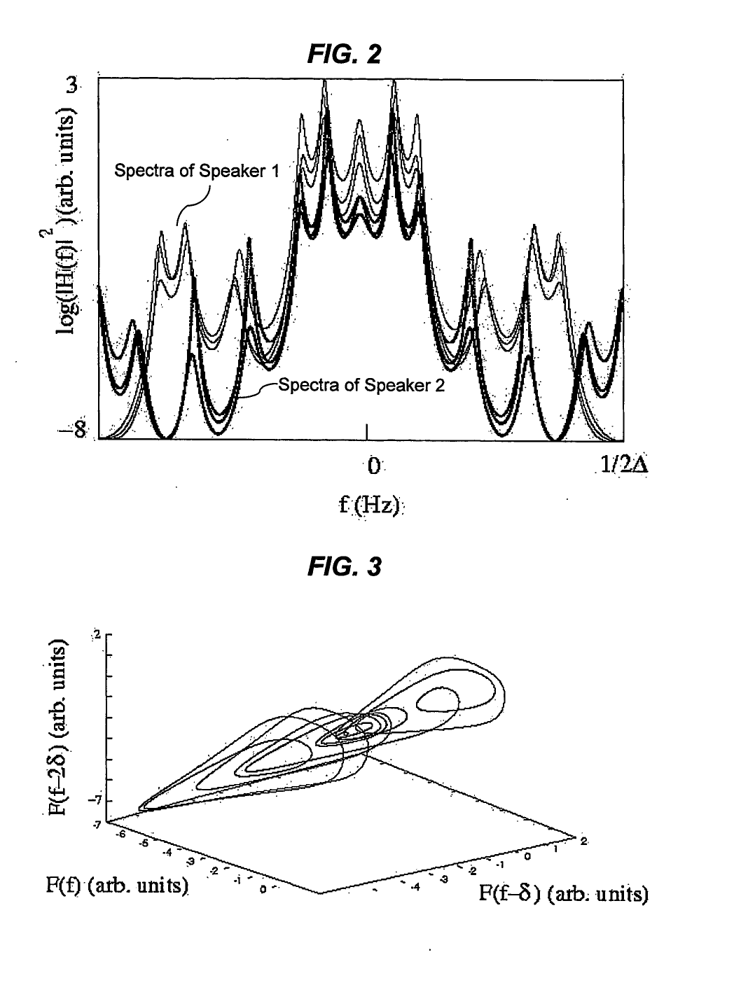

FIG. 2 shows examples of log power spectra of three vocalizations of two speakers. The spectra naturally cluster in two sets that correspond to the two speakers, respectively. The topological properties of their embeddings are found to be a pertinent tool for identity validation.

The relative rotation rates described in the above cited publication by Solari and Gilmore are topological invariants introduced to help in the description of periodically driven two-dimensional dynamical systems and can be used to extract biometric information from spectral properties of human voice. The relative rotation rates can also be constructed for a large class of autonomous dynamical systems in R³: those for which a Poincaré section can be found.

In order to describe the vocal tract frequency response, the maximum entropy approximation of the power spectrum for each of the stored voiced segments is computed. This computation can be performed by calculating m linear predictor coefficients for the voiced segment {yₙ}, sampled with a rate of r=1/Δ:
yₙ=σₖ₌₁^{m}dₖyₙ₋ₖ+xₙ (1)
where the lp coefficients d₁, d₂, . . . dₘ are assumed constant over the speech segment, and are chosen so that Xₙ is minimum. These lp coefficients can be used to estimate the power spectrum |H(ƒ)² as a rational function with m poles:

$$H ( f ) = \frac{{d}_{0}}{1 - {\sum }_{k = 1}^{m} {d}_{k} {ⅇ}^{ⅈ k 2 π f Δ}} \qquad ( 2 )$$

which is periodic in [−½Δ,½Δ] the Nyquist interval. The spectra of two speakers in FIG. 2 are examples of reconstructed spectra based on Equation (2).

The log of power spectral function log log|H(ƒ)|² was approximated using Equation (2) with m=13 coefficients. This spectrum is symmetric with respect to f=0. Therefore only one half of each spectrum is relevant to the analysis and extraction of the topological rational numbers. In processing the original data in the voice spectra, we washed out the difference between log|H(ƒ)|² and log|H(π/Δ)|, adding a linear function and subtracting the average. The final spectral function F(f) is a periodic function and has a period that is one half of the original period.

Referring back to FIG. 1, a few examples of F(f) for different utterances of the same speaker are shown along with a reference spectral function. The resulting function F(f) can be embedded in the phase space using a delay δ. FIG. 3 further shows an example of such an orbit using δ=40 Hz. These delay-embedded orbits in phase space defined by F(f), F(f−δ), and F(f−2δ) always display a hole around the line F(f)=F(f−δ)=F(f−2δ). Therefore a good Poincaré section is given by the semi plane defined by F(f)=F(f−2δ); F(f−δ)<F(f−2δ).

As a topological characterization of these periodic orbits, the relative rotation respect to a reference is chosen. As an example, a universal reference is used: a plain, non articulated vocal tract (a zero hypothesis for voiced sounds). This universal reference is bank-independent and corresponds to the embedding of the power spectrum of an open-closed uniform tube of a given length of 17.5 cm for the examples described in this application.

The relative rotation of these embedded spectra can be calculated as follows by assuming that the orbits have periods P_{A} and P_{B}. A relative rotation matrix MεZ^{PA×PB} for the orbits A and B is constructed and the matrix element Mᵢⱼ corresponds to summing the signed crossings of the i^{th} period of the orbit A relative to the j^{th} period of the orbit B. The signed crossings can be calculated by projecting the two orbits A and B onto a two-dimensional subspace. In this projection, tangent vectors to the two periods just over the cross are drawn in the direction of the flow. The upper tangent vector is rotated into the lower tangent vector, assigning a +1 (−1) to the crossing if the rotation is right (left) handed. The elements of a relative rotation matrix constructed as above are rational numbers.

This relative rotation matrix is related to the relative rotation rates through the following equation:

$${R}_{ij} ( A , B ) = \frac{1}{{p}_{A} {p}_{B}} {\sum }_{k = 0}^{{p}_{A} {p}_{B} - 1} {M}_{i + k , j + k} \qquad ( 3 )$$

where periodic boundary conditions are used for the matrix.

In order to construct a voice signature of the speaker, each of the vowels spoken by the speaker is characterized. One way of characterizing the vowels is by superposing all the relative rotation matrices corresponding to the same voiced sound and the same speaker and by searching for coincidences in these relative rotation matrices, i.e., the rotation numbers which do not change when computed from different utterances made by the speaker. These coincidences are called “robust rotation numbers” and are rational numbers. Tests were conducted and showed that these robust rotation integer numbers for one speaker are unique to that speaker and robust rotation numbers for different speakers are different. Hence, such robust rotation integer numbers for the speaker are similar to fingerprints of the speaker and can be used as voice biometric features for identifying the speaker from others.

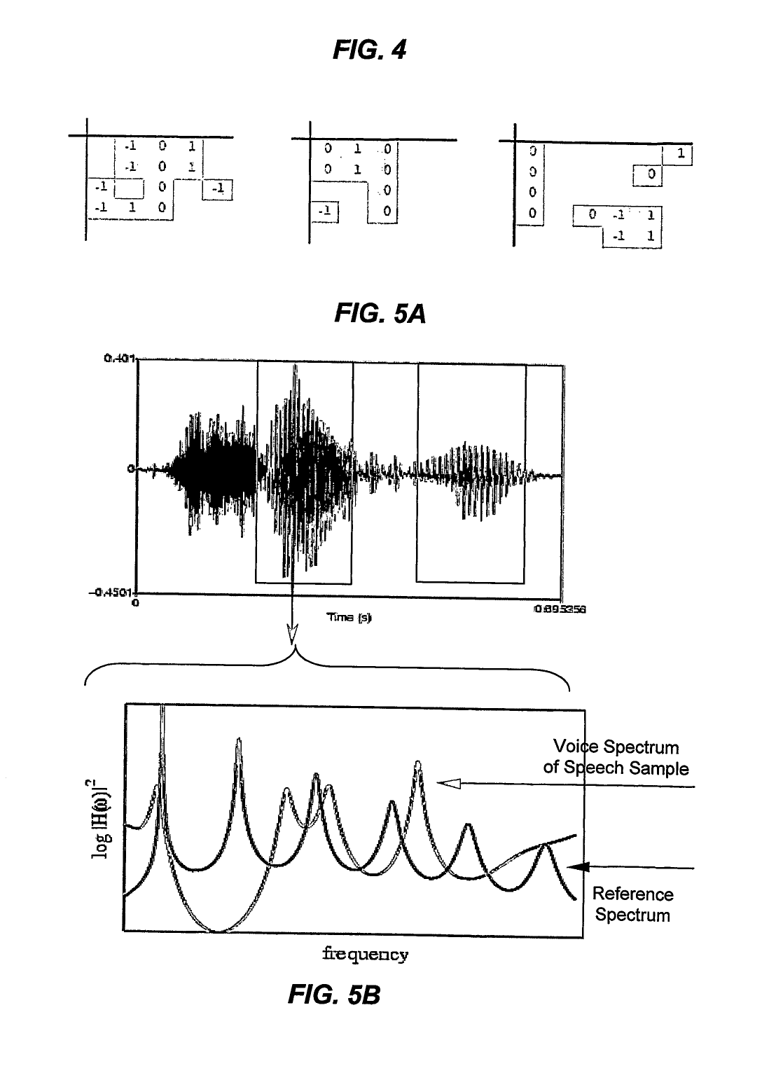

The arrangement of the robust rotation numbers placed in the original matrix sites is referred to as a “vowelprint” for the speaker. A collection of vowelprints of speakers is referred to as a “voiceprint.” FIG. 4 shows three vowelprint examples corresponding to the Spanish vowel [a] for three male subjects of nearly the same age.

A voiceprint as described above is a collection of discrete rational numbers that represents unique vocal biometric features of a speaker. A speaker can be recognized by comparing such rational numbers obtained from the voice of the speaker to a set of rational numbers obtained from a known speaker. This comparison between two sets of discrete rational numbers avoids metric computation of distances between spectral features and the inherent uncertainties in matching different spectral features based on some predetermined threshold. In addition, the sizes of digital files for such rational numbers are relative small when compared to usually large voice data banks for the spectral features in spectral analysis methods. As a result, the voiceprint of a person may be stored as digital codes in various portable storage devices, such as magnetic stripes on credit cards, identification cards (e.g., driver licenses) and bank cards, bar codes printed on various surfaces such as printed documents (e.g., passports and driver licenses) and ID cards, small electronic memory devices, and others. A person can conveniently carry the voiceprint and use the voiceprint for identification, verification and other purposes.

In implementations, computers or a microprocessor-based electronic devices and systems may be used to receive and process the voice signals from speakers and extract the rational numbers for the voiceprints for the speakers. Such voiceprints may be stored for subsequent speaker identification and verification processes. For example, a microphone connected to a computer or microprocessor-based electronic device or system may be used to obtain voice samples from speakers. The voice signals received by the microphone are digitized and the digitized voice signals are then processed using the above described orbits to obtain a set of robust rotation numbers for each speaker as the voiceprint.

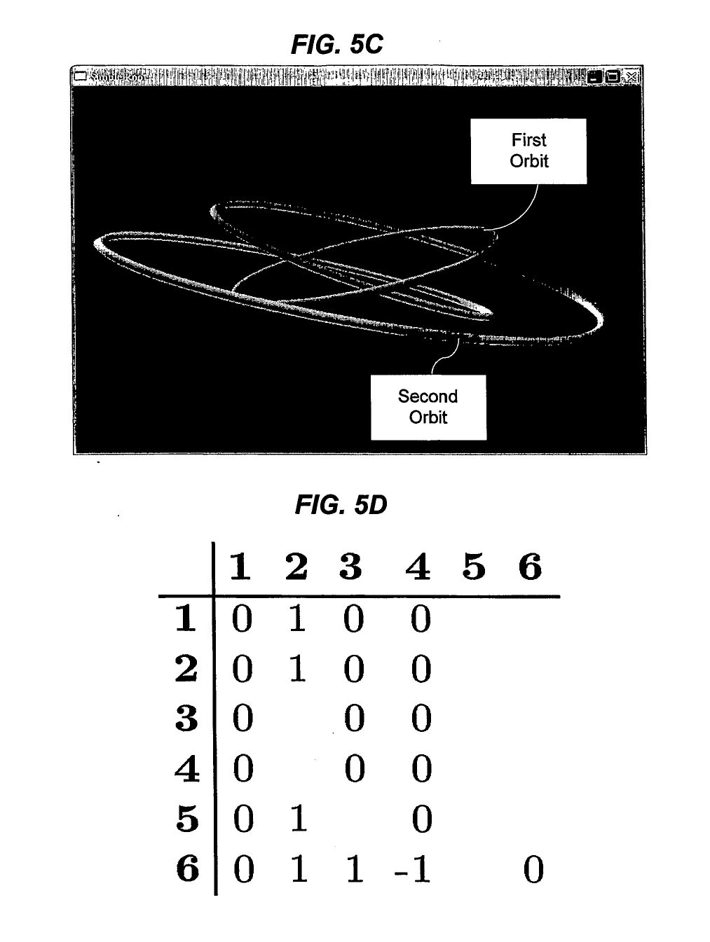

FIG. 5A shows an example of a voice signal as a function of time of a speaker that is produced by a microphone. Segments of the voice signal are selected to form the voice spectra for further processing. FIG. 5B shows one example of a voice power spectrum obtained from one segment of the signal in FIG. 5A and a spectrum of a selected reference voice signal. In actual training of a system, training utterances are recorded from a group of speakers in different enrollment sessions.

FIG. 5C illustrates an example of linking of two simple 3-dimensional orbits 1 and 2. As described above, the knotting and linking of the two orbits 1 and 2 can be used to obtain relative rotation indices or numbers. An orbit generated from the speaker's voice signal like in FIG. 3 and a reference orbit can be used to obtain the relative rotation matrix based on the relative topological relations of the two orbits. FIG. 5D shows an example of the relative rotation integer numbers obtained by the topological analysis of voice samples. To extract the rational numbers, periodic functions based on the spectral features of the recorded voiced sounds are constructed. Closed 3-dimensional orbits are constructed using phase space reconstruction techniques. After the analysis of three-dimensional dynamical systems, linking and knotting properties are extracted from the closed orbits or curves. The extracted sets of rational numbers (rotation numbers) are arranged in a matrix form as shown in FIG. 5D. Next, a mold is then formed from the final arrangement of the rotation numbers that remain invariant for a variety of utterances of each speaker. The matrix consisting only of the robust numbers placed in the original matrix sites may be used to constitute the voice signature, or voice mold, for the speaker.

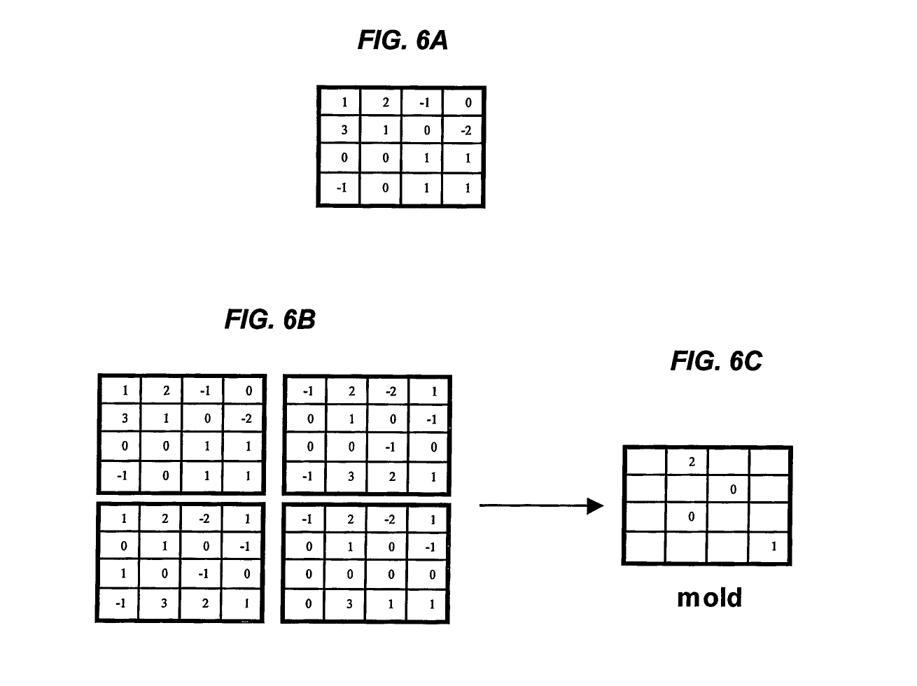

FIGS. 6A, 6B, and 6C illustrate the formation of a voice mold to a particular speaker. The rotation rates of the orbit for the voice signal F(f) relative to the chosen reference can be calculated. For a function F(f) whose embedded orbit has p segments and a reference of q segments, a matrix of p×q rotation numbers can be obtained. FIG. 6A shows an example of a 4×4 matrix of rotation numbers. The matrix element (i,j) of this matrix corresponds to the number of turns of the segment i of the periodic orbit of the speaker relative to the segment j of the reference. Each matrix element is a rotation number. A voice mold is computed as the invariant rotation numbers of all the utterances of the training set. As an example, FIG. 6B shows 4 different matrices obtained from the same speaker for the same voiced sound. Some rotation numbers vary from matrix to another amongst the 4 obtained matrices. FIG. 6B further shows 4 shaded matrix elements that do not change in the 4 matrices. Based on the 4 samples in FIG. 6B, a final matrix for the voice mold is created as shown in FIG. 6C. The matrix for the voice mold is still a p×q matrix as the original matrix except that only the invariant matrix elements remain and the rest matrix elements are left empty. These empty matrix elements correspond to the most varying topological indexes. There is a mold for every speaker and every voiced sound. The above training process is repeated for all speakers in order to establish a voice data bank for molds of all speakers.

After the data bank of voice molds for the known speakers is established and is stored or made accessible by a speaker recognition system, the system is ready to verify or identify a speaker. First, a voice sample from a unknown speaker is obtained and a set of rotation rate matrices from the voice sample of the unknown speaker who claims to be enrolled in the data bank is computed. These test matrices are compared with the corresponding voice mold for each voiced sound. The unknown speaker is verified only if the test matrix fully matches one of the voice molds in the data bank (mold matching). As long as the full-matching criterion is used, no threshold for acceptance and rejection threshold is needed.

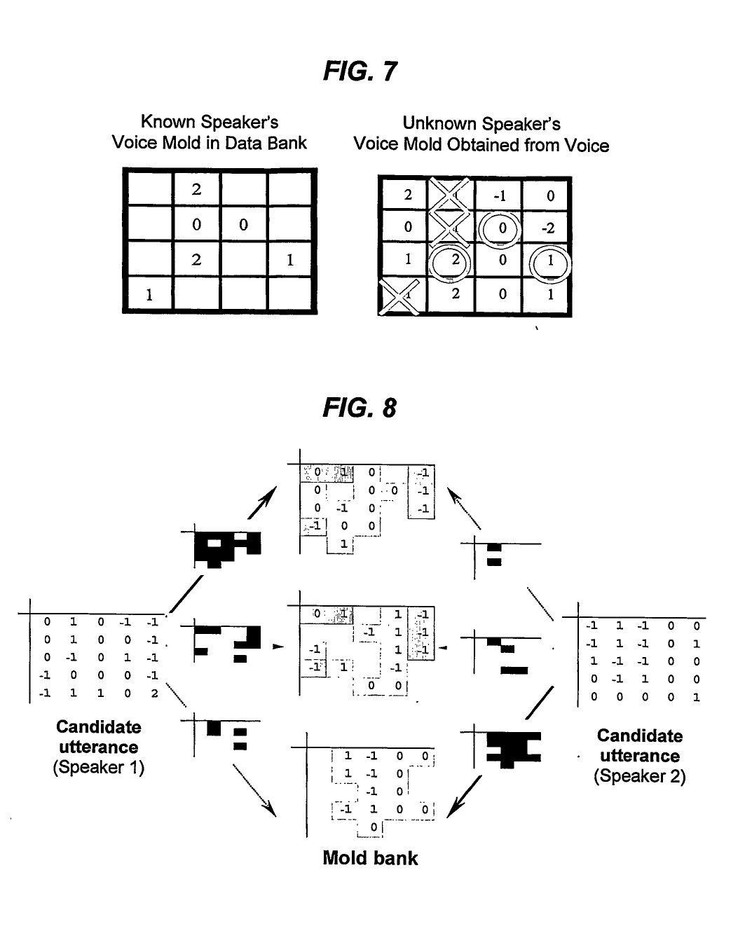

FIG. 7 shows an example of a voice mode for a speaker on the left (e.g., codes stored in a credit card) and a test matrix obtained from an unknown speaker on the right. Out of 6 invariant rotation numbers in the voice mold on the left, the rotation numbers in the matrix on the right only have 3 matches. Therefore, a full match lacks in this example and the unknown speaker is determined not to be the known speaker.

The above topological approach to speaker recognition was successfully tested. A voice bank was constructed by recording six repetitions of a sentence containing five Spanish vowels for each one of 18 speakers, and constructing topological matrices from short fragments (˜100 ms) taken from those vowels. The final voice bank had the voiceprints computed from the topological matrices for each of the 18 speakers.

Next, a voice sample from a speaker who claimed to be in the bank was recorded and topological matrices were computed from the recorded voice sample. These candidate matrices were compared with the corresponding vowelprints in the bank. The speaker was identified as a member of the bank only if the set of candidate matrices fully matches a single stored voiceprint. In this context, full matching means that all the robust numbers in all the vowelprints are present in the corresponding candidate matrices.

FIG. 8 shows an example of this comparison for a single vowelprint obtained from the 18 speakers. In FIG. 8, two candidates were compared with the bank of molds. For each of the two candidates, a single vowel print is shown. A speaker is identified as a member of the bank if the set of the speaker's candidate matrices fully matches a single stored voiceprint. The grey areas in the molds correspond to positions in the matrices that contain robust numbers. Identification of a candidate as a member of the bank (i.e., full matching) requires the numbers in those positions of the candidate's matrix being equal to the robust numbers in the mold. Each of the 108 utterances of the voice bank was used as a candidate for identification. The tests obtained perfect recognition performance without a single false positive or negative identification.

The above choice of a subset of the rotation numbers in the construction of a voiceprint may suggest that some information can be lost. In order to test this hypothesis, each voiceprint in the bank was replaced with the collection of the complete individual matrices used to construct them, in such a way that all the topological information is kept. Each of the 108 utterances of our bank was used as a candidate for identification. Evaluation was made for the number of coincidences between the candidate matrices and the set of matrices characterizing each speaker in the bank. The result was a lower performance method, since several false positives and negatives were found. Therefore, the topological robust numbers seem to strengthen the relevant spectral information, discarding the unnecessary information carried by the indexes that vary the most from one utterance to the next.

In addition, a comparison between the above topological approach and a metric method was made. In the metric method, the quadratic distance between spectra was calculated and coincidences were computed below an optimized threshold. In this case, the voiceprint of each speaker in the bank was replaced by the spectral functions used to construct the rotation matrices. The performance of this metric method as a speaker recognizer was worse than the topologic method.

The present topological approach presents many interesting advantages over various metric methods. In a metric strategy in which some distance between spectra are computed, a threshold has to be defined, and this is a bank dependent quantity. The use of topological voiceprints constructed with rational numbers, along with the full-matching criterion, introduces a novel strategy, which is bank-independent, with no-threshold needed to verify the acceptance.

Implementations of the topological approach running on standard personal computers were conducted and the tests suggest that the topological processing on PCS are fast. Once an utterance is recorded, voiced sounds segments can easily be extracted. Their relative rotation matrices can be built using simple cross-counting algorithms (see, e.g., the cited Gilmore paper) and voiceprints are then computed by simply counting coincidences over a collection of small matrices. Once the voice data bank is constructed, the whole recognition task is the matching of small matrices.

In the present topological approach, the change in the number of robust numbers is found to be a function of the training set size. For training sets larger than 10 vowels, the number of robust numbers converges to approximately 8. These numbers describe the relative heights of the peaks of the spectral function of a voiced sound with respect to the spectrum of a reference, that do not change from utterance to utterance. The robust numbers of a subject in our base were compared with the topological indexes obtained from an utterance recorded when the subject had a strong cold and thus had a changed voice. Tests suggested that the information in the matrix of robust numbers degrades gracefully: only the indexes associated with the highest frequencies changed, while a large part of the voice print remained unaltered.

Various systems may employ the present topological voice recognition method. One simple implementation may use a processing unit that may be a computer or include a microprocessor for processing voice signals from a microphone connected to the processing unit. A storage medium, such an electronic storage device, a magnetic storage device (e.g., harddrive in a PC), or optical storage device, may be used to store the topological voiceprints for known speakers. A user provides a voice sample by speaking to the microphone. The processing unit first processes the voice sample from the user to extract the user's topological voice indices and then compares the user's topological voice indices to the indices stored in the storage device to search for a match between the user and one of the known speakers in the database.

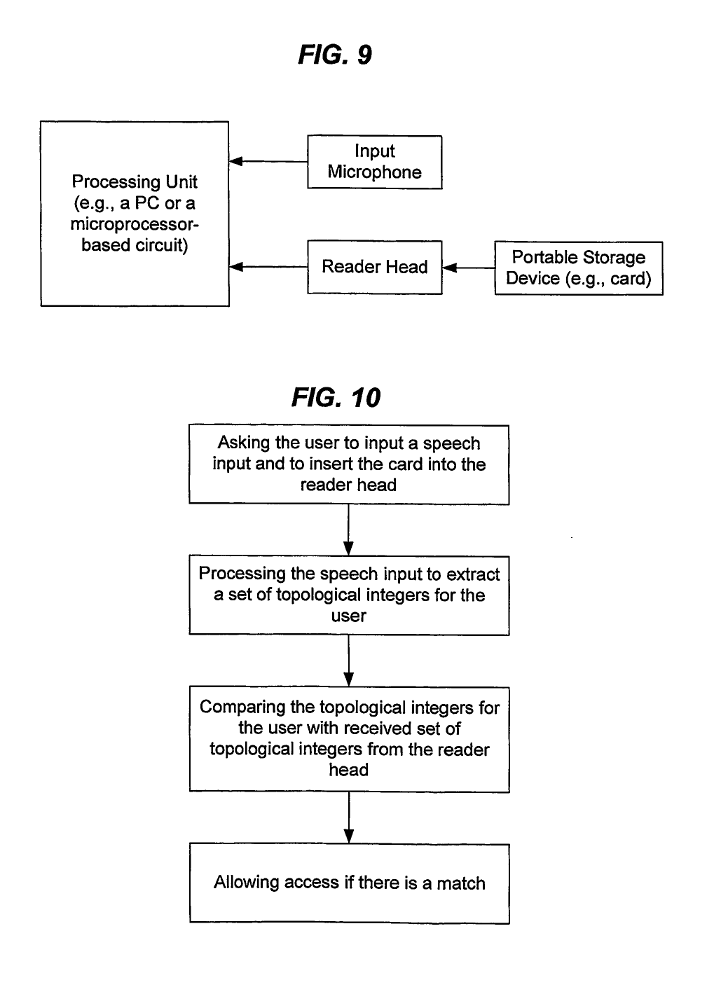

FIG. 9 shows an example of a speaker recognition system that implements the above topological approach. FIG. 10 shows the operational flow of the system in FIG. 9. The system includes a processing unit that may be a computer or include a microprocessor for processing voice signals based on the topological approach and comparing the voice mold read from a reader head and a test matrix constructed from a voice signal. An input microphone is connected to the processing unit and operates to record voice signals from speakers. A reader head is also connected to the processing unit and operates to read stored rational numbers for voice molds for one or more known speakers on a portable storage device such as a magnetic card, an optical an optical storage device, a card printed with a bar code encoded with the rational numbers, or an electronic storage device or memory card.

As an example, the reader head is assumed to be a magnetic reader and the portable storage device is a magnetic card that stores digital codes for one or more voice molds of a known speaker. A card holder who claims to be the known speaker is asked to slide the card through the reader and to speak to the microphone so that his voice samples can be obtained. The processing unit processes the voice samples to extract the topological rational numbers and compare them to the rational numbers read from the card. When there is a full match between all rational numbers, the card user is verified as the known speaker whose voiceprint is stored on the card. An access to, e.g., a bank account or a computer system, can be granted to the card user.

Computer security verification systems based on the present topological approach may be implemented via computer networks where the digitized voice samples from a user may be sent through a network to reach a processing unit that determines whether the user's voice matches a known speaker's voice stored in the topological data bank. Such application may be applied to the Internet, telephone lines and networks, wireless communication links such as wireless phone networks and wireless data networks. Various applications may incorporate the present topological voice recognition as part of or entire verification process such as electronic banking or finance, on-line shopping, verification of various identification documents like passports, ID cards, and verification of user identity in bank cards, credit cards, electronic trading, telephone access, keyless entry (cars, homes, offices, etc.) and driver's licenses.

Only a few implementations are described. However, it is understood that variations and enhancements may be made.

What is claimed is:

1. A method for determining an identity of a speaker by voice, comprising:
extracting a set of topological indices from an embedding of spectral functions of a speaker's voice; and
using a selection of the topological indices as a biometric characterization of the speaker to identify and verify the speaker from other speakers.

2. The method as in claim 1, further comprising:
analyzing a voice sample from a second speaker to extract a set of topological indices for the second speaker;
comparing the set of topological indices for the second speaker to the set of topological indices for the speaker;
verifying the second speaker as the speaker when there is a match between the set topological indices for the second speaker to the set of topological indices for the speaker; and
identifying the second speaker as a person different from the speaker when there is not a match.

3. The method as in claim 1, further comprising:
extracting sets of topological indices from voices of different known speakers;
analyzing a voice sample from an unknown speaker to extract a set of topological indices for the unknown speaker;
comparing the set of topological indices for the unknown speaker to the sets of topological indices for the known speakers to determine whether there is a match; and
when there is match, identifying the unknown speaker as a known speaker whose set of topological indices matches the set of topological indices for the unknown speaker.

4. The method as in claim 1, further comprising:
storing the set of topological indices for the speaker in a portable device;
obtaining a voice sample from a user in possession of the portable device;
analyzing the obtained voice sample form the user to extract a set of topological indices for the user;
providing a reader device to read the set of topological indices for the speaker from the portable device;
comparing the set of topological indices for the speaker read from the portable device and the set of topological indices for the user to determine if there is a match, and
identifying the user as the speaker when there is a match.

5. The method as in claim 4, further comprising using a magnetic storage device as the portable device.

6. The method as in claim 5, wherein the portable device is a magnetic card and the set of topological indices for the speaker is stored in the magnetic card.

7. The method as in claim 6, wherein the magnetic card comprises a magnetic strip that stores the set of topological indices for the speaker.

8. The method as in claim 4, wherein the portable device has a surface that is printed with a bar code pattern and the set of topological indices for the speaker is stored in the bar code pattern.

9. The method as in claim 4, further comprising using an electronic storage device as the portable device.

10. The method as in claim 4, further comprising using an optical storage device as the portable device.

11. The method as in claim 1, wherein the extraction of the set of topological indices from voices of the speaker comprises:
processing the speech signal from the speaker to obtain spectral functions;
constructing closed three-dimensional orbits from the spectral functions;
obtaining a set of topological indices from the orbit with respect to a reference; and
selecting a subset of the topological indices as the biometrical signature for the speaker.

12. A method, comprising:
recording and processing a speech signal from a speaker;
computing linear prediction coefficients from the speech signal;
computing power spectrum from the linear prediction coefficients;
constructing a three-dimensional periodic orbit based on the power spectrum;
constructing a three-dimensional periodic orbit from a power spectrum of a natural reference signal;
obtaining topological information about the periodic orbits of the speech signal and the natural reference signal; and
using a selective set of topological indices to distinguish a speaker who produces the speech signal from other speakers who have different topological indices.

13. The method as in claim 12, wherein the topological information is obtained from relative rotation rates between the periodic orbit of the speech signal and another reference orbit and/or rotation rates of the periodic orbit with itself.

14. The method as in claim 12, wherein the topological information is obtained from an orbit by computing linking properties and/or self linking properties.

15. The method as in claim 12, wherein the topological information is obtained from the orbit by computing a knot type in an embedding.

16. The method as in claim 12, wherein each three-dimensional periodic orbit is constructed with respect to a Cartesian coordinate system with axes defined by the power spectrum with different phase delays.

17. The method as in claim 12, wherein each three-dimensional periodic orbit is constructed with respect to a Cartesian coordinate system with axes defined by other integrodifferential embeddings.

18. The method as in claim 12, further comprising:
forming a database to include different selective sets of topological indices for a plurality of known speakers; and
comparing a selective set of topological indices of an unknown speaker to the database to determine if there is a match.

19. A method, comprising:
providing a database having voice prints of known speakers, wherein each voice print includes a set of topological numbers to distinguish a speaker from other speakers and is derived from a relation between a periodic orbit derived from a power spectrum of the speaker's voice and periodic orbit from a power spectrum of an audio reference in a three-dimensional space; and
comparing a voice print of an unknown speaker to the database to determine if there is a match.

20. The method as in claim 19, wherein the three-dimensional space is defined by power spectrum functions with different delay values.

21. The method as in claim 20, wherein the three-dimensional space is defined as a three-dimensional integrodifferential embedding.

22. A voice print for identifying a speaker from other speakers, comprising:
a set of rational numbers characterising topological features of spectral functions to distinguish a speaker from other speakers,
wherein the topological parameters are derived from a relation between a periodic orbit from a power spectrum of the speaker and periodic orbit for a power spectrum of an audio reference in a three-dimensional space.

23. A speaker recognition system, comprising:
a microphone to receive a voice sample from a speaker;
a reader head to read voice identification data of rational numbers that represent a known speaker from a portable storage device; and
a processing unit connected to the microphone and the reader head, the processing unit operable to extract topological information from the voice sample from the speaker to produce topological rational numbers from the voice sample and to compare the rational numbers of the known speaker to the topological rational numbers from the voice sample to determine whether the speaker is the known speaker.

24. The system as in claim 22, wherein the reader is a magnetic reader which reads data from a magnetic portable storage device.

25. The system as in claim 22, wherein the reader is an optical reader which reads data from an optical portable storage device.

26. The system as in claim 22, wherein the reader is an electronic reader which reads data from an electronic portable storage device.
